(19) United States
(12) Patent Application Publication
(10) Pub. No.: US 2026/0347566 A1
(43) Pub. Date: Nov. 5, 2026

(54) TRANSFER-TYPE SHEET-SHAPED BONDING MATERIAL

(71) Applicant: TAIYO NIPPON SANSO CORPORATION, Shinagawa-ku, Tokyo (JP)

(72) Inventors: Kentaro MIYOSHI, Shinagawa-ku, Tokyo (JP); Hiroshi IGARASHI, Shinagawa-ku, Tokyo (JP); Katsunori TAKADA, Shinagawa-ku, Tokyo (JP)

(73) Assignee: TAIYO NIPPON SANSO CORPORATION, Shinagawa-ku, Tokyo (JP)

(21) Appl. No.: 19/140,532

(22) PCT Filed: Oct. 24, 2023
(86) PCT No.: PCT/JP2023/038371

§ 371 Date: Jun. 18, 2025

(30) Foreign Application Priority Data
Jan. 12, 2023 (JP) 2023-003344

(51) Int. Cl. C08K 3/08; C08K 5/00; C08K 5/134; C08K 5/17

(52) U.S. Cl. CPC C08K 3/08; C08K 5/0016; C08K 5/1345; C08K 5/17; C08K 2003/085

(57) ABSTRACT

Provided is a transfer-type sheet-shaped bonding material with which (I) cracking is sufficiently suppressed, (II) excellent transferability is achieved even with mild transfer conditions under which sintering of copper particles does not proceed, and (III) sufficient bonding strength can be ensured even in low-temperature bonding at 250 °C or lower. The transfer-type sheet-shaped bonding material is obtained through application and drying, on a resin substrate, of a paste that contains copper particles, a reductant, an organic material including a resin and optionally including a plasticizer, and a solvent. The transfer-type sheet-shaped bonding material has a glass-transition point of not lower than −35 °C and not higher than 25 °C.

### TECHNICAL FIELD

The present disclosure relates to a transfer-type sheet-shaped bonding material.

### BACKGROUND

Solder materials have conventionally been used widely as bonding materials for electronic components. However, solder materials have been problematic in terms of having poor heat resistance. Consequently, it has been difficult to use solder materials as bonding materials in power devices including SiC elements that are expected to be used at high temperatures of 150 °C or higher, for example.

Therefore, bonding materials in which silver particles are used have been proposed as sinter-type bonding materials. The use of copper particles is also promising from viewpoints of cost and ion migration, and there is ongoing development of transfer-type sheet-shaped bonding materials in which copper particles are used.

A transfer-type sheet-shaped bonding material is formed by applying a paste containing at least copper particles, a reductant, a resin, and a solvent onto a resin substrate such as a release PET film and drying the paste. Bonding of two members (a first member and a second member) through the transfer-type sheet-shaped bonding material is performed as follows. First, the sheet-shaped bonding material is transferred to the first member under certain transfer conditions, and then the resin substrate is peeled off. Next, the sheet-shaped bonding material that has been transferred onto the first member is brought into contact with the second member, and the first member and the second member are bonded via the sheet-shaped bonding material under certain bonding conditions.

Patent Literature (PTL) 1 describes a sheet-shaped bonding material that is obtained through application and drying, on a PET film, of a paste that contains copper particles (D10: 100 nm or more; D90: 2,000 nm or less) surface coated with triethanolamine as a capping agent, a dicarboxylic acid as an activator, a dispersant, epoxy methacrylate urethane as a bonding agent, and terpineol as an organic solvent. PTL 1 discloses that this sheet-shaped bonding material can be transferred to a Au-plated silicon die under transfer conditions of a transfer temperature of 200 °C to 225 °C, a pressing pressure of 5 MPa, and a transfer time of 1 second to 10 seconds.

### CITATION LIST

### Patent Literature

PTL 1: JP2021-529258A

### SUMMARY

### Technical Problem

However, according to studies conducted by the inventors, a resin referred to as epoxy methacrylate urethane in PTL 1 does not exist, and, even putting this aside, the inventors found that in existing sheet-shaped bonding materials, a resin component that is contained in the sheet-shaped bonding material (dried paste film) causes the formation of cracks in the dried film.

Moreover, the transfer temperature in PTL 1 is 200 °C or higher, which causes sintering of copper during transfer and loss of surface activity of copper particles, and may thereby lead to loss of sintering of copper and diffusion of atoms to a bonded material during subsequent bonding, presenting a problem that sintering properties and atom diffusion (bonding properties) tend to be unstable. When transfer is performed with mild transfer conditions under which sintering of copper particles does not proceed, there is a problem that the sheet-shaped bonding material cannot be transferred to the entire surface of a transfer target or that a residue of a dried paste film (transfer-type sheet-shaped bonding material) remains on a resin substrate.

Another problem with the sheet-shaped bonding material of PTL 1 is that although low-temperature bonding at a bonding temperature of 250 °C or lower is possible, it is difficult to ensure sufficient bonding strength.

In view of the problems described above, an object of the present disclosure is to provide a transfer-type sheet-shaped bonding material with which (I) cracking is sufficiently suppressed, (II) excellent transferability is achieved even with mild transfer conditions under which sintering of copper particles does not proceed, and (III) sufficient bonding strength can be ensured even in low-temperature bonding at 250 °C or lower.

### Solution to Problem

The inventors conducted diligent studies with the aim of solving the problems described above and found that with a transfer-type sheet-shaped bonding material that is obtained through application and drying, on a resin substrate, of a paste that contains copper particles, a reductant, an organic material including a resin and optionally including a plasticizer, and a solvent, the problems described above in (I) to (III) can be solved through optimization of the glass-transition point of the transfer-type sheet-shaped bonding material.

The present disclosure was completed based on this finding and has the following primary configurations.

[1] A transfer-type sheet-shaped bonding material obtained through application and drying, on a resin substrate, of a paste that comprises copper particles, a reductant, an organic material including a resin and optionally including a plasticizer, and a solvent, wherein
the transfer-type sheet-shaped bonding material has a glass-transition point of not lower than −35 °C and not higher than 25 °C.

[2] The transfer-type sheet-shaped bonding material according to the foregoing [1], wherein the resin is composed of an acrylic resin.

[3] The transfer-type sheet-shaped bonding material according to the foregoing [1] or [2], wherein content of the resin is not less than 1.0 parts by mass and not more than 5.0 parts by mass relative to 100 parts by mass of the copper particles.

[4] The transfer-type sheet-shaped bonding material according to any one of the foregoing [1] to [3], wherein the plasticizer is composed of one or more selected from the group consisting of butyl phthalyl butyl glycolate, dimethyl phthalate, dioctyl phthalate, and diisodecyl phthalate.

[5] The transfer-type sheet-shaped bonding material according to any one of the foregoing [1] to [4], wherein content of the plasticizer is not less than 10 parts by mass and not more than 50 parts by mass relative to 100 parts by mass of the resin.

[6] The transfer-type sheet-shaped bonding material according to any one of the foregoing [1] to [5], wherein the reductant is composed of triethanolamine.

[7] The transfer-type sheet-shaped bonding material according to any one of the foregoing [1] to [6], wherein content of the reductant is not less than 3 parts by mass and not more than 9 parts by mass relative to 100 parts by mass of the copper particles.

[8] The transfer-type sheet-shaped bonding material according to any one of the foregoing [1] to [7], wherein the copper particles have a mean particle diameter of not less than 70 nm and not more than 300 nm.

### Advantageous Effect

With a transfer-type sheet-shaped bonding material according to the present disclosure, (I) cracking is sufficiently suppressed, (II) excellent transferability is achieved even with mild transfer conditions under which sintering of copper particles does not proceed, and (III) sufficient bonding strength can be ensured even in low-temperature bonding at 250 °C or lower.

### DETAILED DESCRIPTION

### [Transfer-Type Sheet-Shaped Bonding Material]

A transfer-type sheet-shaped bonding material according to one embodiment of the present disclosure is obtained through application and drying, on a resin substrate, of a paste that contains copper particles, a reductant, an organic material including a resin and optionally including a plasticizer, and a solvent, and this transfer-type sheet-shaped bonding material has a glass-transition point of not lower than −35 °C and not higher than 25 °C.

### (Copper Particles)

The copper particles have copper as a main component. The copper particles preferably contain not less than 95 mass % and not more than 100 mass % of copper element, and more preferably contain 97 mass % or more of copper element relative to 100 mass % of the copper particles. The inclusion of 95 mass % or more of copper element results in the bonding material having excellent heat resistance and even better bonding force.

The mean particle diameter of the copper particles is preferably 300 nm or less. Through the mean particle diameter of the copper particles being 300 nm or less, sufficiently high bonding strength can be ensured even in low-temperature bonding at 250 °C or lower. The mean particle diameter of the copper particles is more preferably 150 nm or less. Moreover, the mean particle diameter of the copper particles is preferably 5 nm or more. When the mean particle diameter of the copper particles is 5 nm or more, this makes it easy to acquire the copper particles. The mean particle diameter of the copper particles is more preferably 70 nm or more. Through the mean particle diameter of the copper particles being 70 nm or more, sufficiently high bonding strength can be ensured even in low-temperature bonding at 250 °C or lower.

No specific limitations are placed on the shape (form) of the copper particles. The shape of the copper particles may be a spherical shape (sphere), an elliptical shape (ellipsoid), a plate shape, or the like, of which, a spherical shape or an elliptical shape is preferable, and a spherical shape is more preferable.

The mean particle diameter of the copper particles can be determined by observing 10 viewing fields at ×10,000 magnification using a scanning electron microscope (SEM), measuring the particle diameter of each copper particle among all copper particles selected according to the following selection criteria (1) to (5) in the 10 viewing fields, and calculating D50 of the measured particle diameters. Note that in the case of a particle that is an ellipse or the like rather than a perfect circle, the major axis is taken to be the particle diameter. Also note that a particle size distribution of the copper particles is also determined based on the particle diameters of all copper particles taken as the measurement subjects described above. In a situation in which the mean particle diameter and the particle size distribution of the copper particles are to be determined with the copper particles in the sheet-shaped bonding material, an outermost surface portion of the sheet is observed. In the case of a powder state prior to sheet production, the powder is placed on carbon tape using a spatula, excess powder is removed by an air duster, and the surface of the tape is observed.
(1) Particles that partially protrude outside of a viewing field of an image are not measured.
(2) Particles that have a clear contour and are present in isolation are measured.
(3) Particles that are independent and can be measured as individual particles are measured even when they deviate from the average particle shape.
(4) Overlapping particles for which there is a clear boundary between the particles and for which the overall particle shape can be judged are each measured as an individual particle.
(5) Overlapping particles for which there is not a clear boundary and for which the overall particle shape is unknown are considered to have particle shapes that cannot be judged and are not measured.

The copper particles are preferably copper particles that do not require a protective agent, a dispersant, or the like. Examples of such copper particles include ultrafine metal powder obtained through a production method described in JP4304221B2. However, the copper particles are not limited to this example.

The copper particles preferably have a coating film containing copper carbonate at the surface. The inclusion of a coating film containing copper carbonate at the surface of the copper particles makes it possible to increase bonding force while also restricting the sintering temperature of the copper particles to a lower temperature than conventionally adopted. The coating film containing copper carbonate may further contain cuprous oxide.

The copper particles are preferably copper particles that are not covered by an organic protective film. In a case in which the copper particles are covered by an organic protective film, it is necessary to adopt a bonding temperature that is not lower than a decomposition temperature of the organic protective film because sintering of the copper particles does not proceed until the organic protective film decomposes, and hence it may not be possible to perform low-temperature bonding at 250 °C or lower. Moreover, there is a risk that decomposition gas of the organic protective film may form voids in a bonding layer or cause cracking of the bonding layer, and thus may reduce reliability.

A ratio of the mass oxygen concentration relative to the specific surface area of the copper particles is preferably 0.1 mass %·g/m² or more, and more preferably 0.2 mass %·g/m² or more from a viewpoint of lowering reactivity with oxygen in air and reducing the influence of reoxidation. On the other hand, the ratio of the mass oxygen concentration relative to the specific surface area of the copper particles is preferably 1.2 mass %·g/m² or less, and more preferably 0.5 mass %·g/m² or less from a viewpoint of facilitating removal of an oxide film during bonding and further increasing bonding force.

A ratio of the mass carbon concentration relative to the specific surface area of the copper particles is preferably 0.3 mass %·g/m² or less, more preferably 0.1 mass %·g/m² or less, and even more preferably 0.05 mass %·g/m² or less from a viewpoint of inhibiting the formation of voids and cracks and further increasing bonding force. The ratio of the mass carbon concentration relative to the specific surface area of the copper particles is preferably 0.008 mass %·g/m² or more.

The ratio of the mass oxygen concentration relative to the specific surface area of the copper particles can be calculated from measured values for the specific surface area and the mass oxygen concentration. The specific surface area can be measured using a nitrogen gas BET adsorption instrument (for example, MACSORB HM-1201 produced by Mountech Co., Ltd.). The mass oxygen concentration can be measured using an oxygen/nitrogen analyzer (for example, TC600 produced by LECO Corporation).

The ratio of the mass carbon concentration relative to the specific surface area of the copper particles can be calculated from measured values for the specific surface area and the mass carbon concentration. The specific surface area can be measured using a nitrogen gas BET adsorption instrument (for example, MACSORB HM-1201 produced by Mountech Co., Ltd.). The mass carbon concentration can be measured using a carbon/sulfur analyzer (for example, EMIA-920V produced by Horiba, Ltd.).

The “content of the copper particles” in the sheet-shaped bonding material is equal to the content of the copper particles in the paste and can be determined, for example, from the weight of the sheet after the sheet has been heated to approximately 1000 °C in a nitrogen atmosphere.

### (Reductant)

The reductant is a compound that reduces an oxide film that is unavoidably present at the surface of the copper particles at the time of bonding. By removing the oxide film through the reductant at the time of bonding, the copper particles (pure copper) come into contact with one another, sintering of the copper particles proceeds, and diffusion bonding proceeds.

In the present embodiment, it is preferable that the reductant is composed of triethanolamine. Triethanolamine has a high oxide film removal effect and also has a high boiling point and low volatility. Consequently, triethanolamine does not easily escape during transfer and has high stability over time, thus resulting in excellent storage stability prior to bonding.

In the present embodiment, the content of the reductant is preferably not less than 3 parts by mass and not more than 9 parts by mass relative to 100 parts by mass of the copper particles. When the content of the reductant is 3 parts by mass or more, there is a sufficient amount of the reductant, and sufficient sintering of the copper particles occurs and sufficiently high bonding strength can be ensured even in low-temperature bonding at 250 °C or lower. Moreover, when the content of the reductant is 9 parts by mass or less, seeping of the reductant is unlikely to arise during transfer and during bonding, and it is possible to achieve transfer and bonding with the same shape as that of a bonded material. Furthermore, the amount of a decomposition gas component does not increase, and the formation of voids or cracks in a bonding layer is unlikely to occur.

Note that the content of the reductant in the sheet-shaped bonding material is equal to the content of the reductant in the paste.

### (Organic Material)

In the present embodiment, the organic material includes a resin and optionally includes a plasticizer.

### <Resin>

The resin functions as an adhesive when the transfer-type bonding sheet is transferred to a first member. A resin that can also function as a dispersant for dispersing the copper particles is even better.

The resin is preferably an acrylic resin, an aliphatic polycarbonate, or the like that is a binder having high decomposability. In particular, it is preferable that the resin is composed of an acrylic resin. This is because an acrylic resin has excellent transferability due to the adhesive functionality thereof. Specifically, the acrylic resin can be one or more selected from a polymethacrylic acid alkyl ester, a polyalkyl methacrylate, and a methacrylic acid ester-based copolymer.

In the present embodiment, the content of the resin is preferably not less than 1.0 parts by mass and not more than 5.0 parts by mass relative to 100 parts by mass of the copper particles. In a situation in which the content of the resin is less than 1.0 parts by mass, this makes it easier for cracks to form in a dried paste film and also makes it harder to achieve excellent transferability with mild transfer conditions under which sintering of the copper particles does not proceed. Moreover, in a situation in which the content of the resin exceeds 5.0 parts by mass, sufficient bonding strength cannot be ensured in low-temperature bonding at 250 °C or lower because a decomposable component or undecomposed material in the binder forms voids in a bonding layer, and close adherence with a bonded material is lost.

Note that the content of the resin in the sheet-shaped bonding material is equal to the content of the resin in the paste.

### <Plasticizer>

The plasticizer fulfills a role of lowering the glass-transition point of the sheet-shaped bonding material and imparting flexibility to the sheet, and also of suppressing drying contraction of an applied film containing the copper particles.

The plasticizer can be one or more selected from dimethyl phthalate, diethyl phthalate, diallyl phthalate, dibutyl phthalate, diisobutyl phthalate, di-n-hexyl phthalate, bis(2-ethylhexyl) phthalate, dioctyl phthalate, di-n-octyl phthalate, diisononyl phthalate, diisodecyl phthalate, dinonyl phthalate, bisbutylbenzyl phthalate, and butyl phthalyl butyl glycolate. In particular, the plasticizer is preferably composed of one or more selected from the group consisting of butyl phthalyl butyl glycolate, dimethyl phthalate, dioctyl phthalate, and diisodecyl phthalate.

In the present embodiment, the content of the plasticizer is preferably not less than 10 parts by mass and not more than 50 parts by mass relative to 100 parts by mass of the resin. In a situation in which the content of the plasticizer is less than 10 parts by mass, a plasticization effect is not readily displayed, which makes it easier for cracks to form in a dried paste film and also makes it harder to achieve excellent transferability with mild transfer conditions under which sintering of the copper particles does not proceed. Moreover, sufficient bonding strength cannot be ensured in low-temperature bonding at 250 °C or lower because sintering of the copper particles may occur during transfer. Furthermore, in a situation in which the content of the plasticizer exceeds 50 parts by mass, poor dispersion of the copper particles, the binder, and the reductant in the paste is likely to arise, which makes it harder to achieve excellent transferability with mild transfer conditions under which sintering of the copper particles does not proceed, and sufficient bonding strength cannot be ensured in low-temperature bonding at 250 °C or lower.

Note that the content of the plasticizer in the sheet-shaped bonding material is equal to the content of the plasticizer in the paste.

### <Glass-Transition Point of Transfer-Type Sheet-Shaped Bonding Material>

It is important that the transfer-type sheet-shaped bonding material of the present embodiment has a glass-transition point of not lower than −35 °C and not higher than 25 °C. Through the glass-transition point of the transfer-type sheet-shaped bonding material being 25 °C or lower, a flexible transfer-type sheet-shaped bonding material can be obtained, (I) cracking is sufficiently suppressed, (II) excellent transferability is achieved even with mild transfer conditions under which sintering of the copper particles does not proceed, and (III) sufficient bonding strength can be ensured even in low-temperature bonding at 250 °C or lower. From this viewpoint, the glass-transition point of the transfer-type sheet-shaped bonding material is preferably 10 °C or lower. On the other hand, in a situation in which the glass-transition point of the transfer-type sheet-shaped bonding material is too low, it may not be possible to transfer the sheet-shaped bonding material from the resin substrate. Therefore, the glass-transition point of the transfer-type sheet-shaped bonding material is set as −35 °C or higher, and is preferably set as −20 °C or higher.

The glass-transition point of the transfer-type sheet-shaped bonding material can be controlled mainly through the type of the resin and the type and content of the plasticizer.

The glass-transition point of the transfer-type sheet-shaped bonding material can be determined by peeling the dried paste film (transfer-type sheet-shaped bonding material) from the resin substrate and subjecting a resultant powder to differential scanning calorimetry. For example, the glass-transition point can be determined by loading 20 mg of a dry powder of the paste (product dried at 70 °C for 60 minutes) into a differential scanning calorimeter (DSC60) produced by Shimadzu Corporation, performing measurement thereof under conditions of a measurement range of −50 °C to 150 °C (heating rate: 10 °C/min) and a nitrogen atmosphere (flow rate: 50 mL/min) to obtain a DSC thermograph, and, when the baseline shifts downward due to the glass transition, calculating a midpoint of displacement relative to the original baseline as the glass-transition point.

### (Solvent)

The solvent is preferably a solvent having a boiling point of approximately 200 °C and having low volatility. This is because variation of thickness of an applied film will arise in a situation in which the solvent evaporates and the metal concentration changes during application of the paste. In addition, the solvent is required to be a solvent that can dissolve the used resin. A terpene-based solvent such as terpineol, for example, can be used from these viewpoints.

### (Sheet Shape)

The bonding material of the present embodiment is sheet-shaped. The thickness of the bonding material is not specifically limited and can be set as not less than 10 μm and less than 1 mm, for example.

Moreover, the shape (shape in plan view from a thickness direction) of the bonding material is not specifically limited and can be selected as appropriate according to the shape of a bonding surface of a bonded member, for example. For example, the bonding material may have a rectangular shape or a circular shape.

### [Production Method of Transfer-Type Sheet-Shaped Bonding Material]

The transfer-type sheet-shaped bonding material of the present embodiment can be produced through application and drying, on the resin substrate, of the paste that contains the copper particles, the reductant, the organic material including the resin and optionally including the plasticizer, and the solvent.

No specific limitations are placed on the method by which the paste is produced. For example, the paste can be produced by mixing the components by a method using a planetary mixer, a mortar, a mill, a stirrer, or the like. No specific limitations are placed on the method by which the paste is applied onto and dried on the resin substrate. For example, the paste can be applied onto the resin substrate using an applicator, and then the applied film can be dried in a hot air oven to obtain a dried paste film. The drying conditions can be set as a drying time of 10 minutes to 90 minutes at 50 °C to 110 °C (atmosphere temperature).

The resin substrate is not specifically limited and can be a release PET film, silicon film, fluororesin film, or the like, for example. The thickness of the resin substrate can be set as approximately 50 μm to 200 μm in consideration of releasability.

Bonding of two members (a first member and a second member) through the transfer-type sheet-shaped bonding material is performed through two steps of transfer and bonding described below.

### (Transfer)

First, the sheet-shaped bonding material is bonded to the first member, and then the resin substrate is peeled off. In other words, the sheet-shaped bonding material is transferred to the first member. Although no specific limitations are placed on the conditions when the transfer-type sheet-shaped bonding material that has been formed on the resin substrate is transferred to the first member, excellent transferability is achieved in the present embodiment even with mild transfer conditions under which sintering of the copper particles does not proceed, such as a transfer temperature of 150 °C or lower, a pressing pressure of 10 MPa or less, and a transfer time of 1 minute or less. The transfer conditions can be set within ranges of a transfer temperature of 50 °C to 150 °C, a pressing pressure of 1 MPa to 10 MPa, and a transfer time of 10 seconds to 1 minute. The atmosphere during transfer is preferably set as an inert atmosphere such as nitrogen (N₂).

### (Bonding)

Next, the sheet-shaped bonding material that has been transferred onto the first member is brought into contact with the second member, and the first member and the second member are bonded via the sheet-shaped bonding material under certain bonding conditions. Although no specific limitations are placed on the bonding conditions, sufficient bonding strength can be ensured in the present embodiment even in low-temperature bonding at 250 °C or lower. The bonding conditions can be set within ranges of a bonding temperature of 200 °C to 250 °C, a pressing pressure of 1 MPa to 40 MPa, and a transfer time of 1 minute to 60 minutes. The atmosphere during bonding is preferably set as an inert atmosphere such as nitrogen (N₂).

### EXAMPLES

### [Production of Transfer-Type Sheet-Shaped Bonding Material]

### Test Example No. 1

A paste was obtained by mixing 40 g of copper particles (110 nm particle diameter product; D10: 39 nm; D50: 112 nm; D90: 310 nm) produced by Taiyo Nippon Sanso Corporation, 3.2 g of triethanolamine as a reductant, 1.78 g of an acrylic binder (OLYCOX KC-500 produced by Kyoeisha Chemical Co., Ltd.), and 12.2 g of terpineol as a solvent in a planetary mixer. Note that the surface of the copper particles was covered by cuprous oxide and that the copper particles had a ratio of mass oxygen concentration relative to specific surface area of 0.25 mass %·g/m² and a ratio of mass carbon concentration relative to specific surface area of 0.03 mass %·g/m².

Next, the produced paste was applied onto a release PET film of 100 μm in thickness using an applicator such as to have an applied film thickness of 200 μm, and then the applied film was dried under conditions of 60 minutes at 70 °C in a hot air oven to remove terpineol and obtain a dried paste film (transfer-type sheet-shaped bonding material). The formulation of the obtained transfer-type sheet-shaped bonding material and the glass-transition point of the transfer-type sheet-shaped bonding material as measured by the previously described method are shown in Table 1.

### Test Examples Nos. 2 to 26

Pastes were obtained in the same way as in Test Example No. 1 with the content of copper particles fixed at 40 g, but with the type of copper particles, the type and content of reductant, the type and content of acrylic binder, and the type and content of plasticizer changed as shown in Table 1. Note that the content of terpineol was set such that the concentration of the copper particles in the paste was 70 mass %. Next, dried paste films (transfer-type sheet-shaped bonding materials) were obtained in the same way as in Test Example No. 1. The formulations of the obtained transfer-type sheet-shaped bonding materials and the glass-transition points of organic materials as measured by the previously described method are shown in Table 1.

### [Evaluation of Cracking of Dried Paste Film]

In each Test Example, the dried paste film (transfer-type sheet-shaped bonding material) was observed in 10 viewing fields at ×20 magnification using a microscope. An evaluation of “Excellent” was given in a case in which there was no cracking in all 10 of the viewing fields, whereas an evaluation of “Poor” was given in a case in which there was cracking in even one viewing field. The evaluation is indicated in the “Cracking resistance of dried paste film” column in Table 1. Note that in the case of a “Poor” evaluation in which there was cracking of the dried film, subsequent tests for transfer and bonding were not performed because the cracking pattern and degree of cracking cannot be controlled, and thus variation of shear strength would arise in a bonded sample after bonding.

### [Evaluation of Transferability]

In each Test Example, Au-plated SiC (4 mm-square, thickness 350 μm) was mounted on the transfer-type sheet-shaped bonding material, and the transfer-type sheet-shaped bonding material was transferred to a Au-plated surface of the SiC under transfer conditions of a transfer temperature (atmosphere temperature) of 150 °C, a pressing pressure of 10 MPa, a transfer time of 30 seconds, and an atmosphere of N₂. An evaluation of “Excellent” was given in a case in which the sheet-shaped bonding material could be transferred onto the entire surface of the SiC and in which there was no residue of the dried paste film (transfer-type sheet-shaped bonding material) on the release PET film, whereas an evaluation of “Poor” was given in a case in which the sheet-shaped bonding material could not be transferred onto the entire surface of the SiC or in which residue of the dried paste film (transfer-type sheet-shaped bonding material) remained on the release PET film. The evaluation is indicated in the “Transferability” column in Table 1. Note that in the case of “Poor” transferability, a subsequent test of bonding was not performed because variation of shear strength would arise in a bonded sample after bonding.

### [Evaluation of Shear Strength of Bonded Product]

In each Test Example, the transfer-type sheet-shaped bonding material that had been transferred onto the SiC and an oxygen-free copper plate C1020 (20 mm-square, thickness 2 mm) were brought into contact, and the SiC and the oxygen-free copper plate were bonded via the sheet-shaped bonding material in a pressure bonding apparatus under bonding conditions of a bonding temperature (atmosphere temperature) of 250 °C, a pressing pressure of 10 MPa, a bonding time of 5 minutes, and an atmosphere of N₂ so as to produce a bonded product. The shear strength of the bonded product was measured using a bond tester (4000Plus produced by Nordson DAGE) with the tool height set as 100 μm and the tool speed set as 200 μm/s. The shear strength is shown in Table 1. A shear strength of 50 MPa or more is good.

[Evaluation of Seeping of Bonding Layer after Bonding]

In each Test Example, the periphery of the SiC in the bonded product was observed at ×20 magnification using a microscope (L-KIT504 produced by Hozan Co., Ltd.). The presence or absence of liquid seeping around the periphery of the SiC was checked and is indicated in Table 1.

TABLE 1

| | Transfer-type sheet-shaped bonding material | | | | | | | |
|---|---|---|---|---|---|---|---|---|
| | | | | Organic material | | | | Glass- |
| | Copper | Reductant | | Acrylic binder | | Plasticizer | | transition |
| | particles | | Content | | Content | | Content | point |
| No. | *1 | Type | *2 | Type | *3 | Type | *4 | (°C) |
| 1 | 110 nm product | TEA | 8 | OLYCOX KC-500 | 2 | — | — | 6 |
| 2 | 110 nm product | TEA | 8 | OLYCOX KC-500 | 1.5 | — | — | 5 |
| 3 | 110 nm product | TEA | 8 | OLYCOX KC-500 | 1 | — | — | 7 |
| 4 | 110 nm product | TEA | 8 | OLYCOX KC-1700 | 2 | — | — | 40 |
| 5 | 110 nm product | TEA | 8 | OLYCOX KC-1700 | 2 | Butyl phthalyl butyl glycolate | 5 | 31 |
| 6 | 110 nm product | TEA | 8 | OLYCOX KC-1700 | 2 | Butyl phthalyl butyl glycolate | 10 | 25 |
| 7 | 110 nm product | TEA | 8 | OLYCOX KC-1700 | 2 | Butyl phthalyl butyl glycolate | 25 | −5 |
| 8 | 110 nm product | TEA | 8 | OLYCOX KC-1700 | 2 | Butyl phthalyl butyl glycolate | 35 | −18 |
| 9 | 110 nm product | TEA | 8 | OLYCOX KC-1700 | 2 | Butyl phthalyl butyl glycolate | 50 | −35 |
| 10 | 110 nm product | TEA | 8 | OLYCOX KC-1700 | 2 | Butyl phthalyl butyl glycolate | 65 | −40 |
| 11 | 110 nm product | TEA | 8 | OLYCOX KC-1700 | 0.6 | Butyl phthalyl butyl glycolate | 25 | −2 |
| 12 | 110 nm product | TEA | 8 | OLYCOX KC-1700 | 1 | Butyl phthalyl butyl glycolate | 25 | −4 |
| 13 | 110 nm product | TEA | 8 | OLYCOX KC-1700 | 5 | Butyl phthalyl butyl glycolate | 25 | −6 |
| 14 | 110 nm product | TEA | 8 | OLYCOX KC-1700 | 6 | Butyl phthalyl butyl glycolate | 25 | −6 |
| 15 | 110 nm product | TEA | 2 | OLYCOX KC-1700 | 2 | Butyl phthalyl butyl glycolate | 25 | −5 |
| 16 | 110 nm product | TEA | 3 | OLYCOX KC-1700 | 2 | Butyl phthalyl butyl glycolate | 25 | −6 |
| 17 | 110 nm product | TEA | 9 | OLYCOX KC-1700 | 2 | Butyl phthalyl butyl glycolate | 25 | −5 |
| 18 | 110 nm product | TEA | 10 | OLYCOX KC-1700 | 2 | Butyl phthalyl butyl glycolate | 25 | −7 |
| 19 | 50 nm product | TEA | 8 | OLYCOX KC-1700 | 2 | Butyl phthalyl butyl glycolate | 25 | −6 |
| 20 | 70 nm product | TEA | 8 | OLYCOX KC-1700 | 2 | Butyl phthalyl butyl glycolate | 25 | −4 |
| 21 | 100 nm product | TEA | 8 | OLYCOX KC-1700 | 2 | Butyl phthalyl butyl glycolate | 25 | −4 |
| 22 | 300 nm product | TEA | 8 | OLYCOX KC-1700 | 2 | Butyl phthalyl butyl glycolate | 25 | −5 |
| 23 | 400 nm product | TEA | 8 | OLYCOX KC-1700 | 2 | Butyl phthalyl butyl glycolate | 25 | −7 |
| 24 | 110 nm product | TEA | 8 | OLYCOX KC-1700 | 2 | Dimethyl phthalate | 25 | 0 |
| 25 | 110 nm product | TEA | 8 | OLYCOX KC-1700 | 2 | Dioctyl phthalate | 25 | −10 |
| 26 | 110 nm product | TEA | 8 | OLYCOX KC-1700 | 2 | Diisodecyl phthalate | 25 | −12 |

| | Evaluation | | | | |
|---|---|---|---|---|---|
| | | | Shear | Seeping | |
| | Cracking | | strength | of | |
| | resistance | | of bonded | bonding | |
| | of dried | | product | layer after | |
| No. | paste film | Transferability | (MPa) | bonding | Classification |
| 1 | Excellent | Excellent | 50.2 | No | Example |
| 2 | Excellent | Excellent | 95.3 | No | Example |
| 3 | Excellent | Excellent | 96.2 | No | Example |
| 4 | Poor | — | — | — | Comparative Example |
| 5 | Poor | — | — | — | Comparative Example |
| 6 | Excellent | Excellent | 78.2 | No | Example |
| 7 | Excellent | Excellent | 90.2 | No | Example |
| 8 | Excellent | Excellent | 60.3 | No | Example |
| 9 | Excellent | Excellent | 52.2 | No | Example |
| 10 | Excellent | Poor | — | — | Comparative Example |
| 11 | Poor | — | — | — | Comparative Example |
| 12 | Excellent | Excellent | 94.2 | No | Example |
| 13 | Excellent | Excellent | 62.2 | No | Example |
| 14 | Excellent | Excellent | 40.1 | No | Example |
| 15 | Excellent | Excellent | 32.7 | No | Example |
| 16 | Excellent | Excellent | 56.9 | No | Example |
| 17 | Excellent | Excellent | 92.3 | No | Example |
| 18 | Excellent | Excellent | 96.2 | Yes | Example |
| 19 | Excellent | Excellent | 39.9 | No | Example |
| 20 | Excellent | Excellent | 82.9 | No | Example |
| 21 | Excellent | Excellent | 89.1 | No | Example |
| 22 | Excellent | Excellent | 62.4 | No | Example |
| 23 | Excellent | Excellent | 45.4 | No | Example |
| 24 | Excellent | Excellent | 93.1 | No | Example |
| 25 | Excellent | Excellent | 79.9 | No | Example |
| 26 | Excellent | Excellent | 69.9 | No | Example |

*1
110 nm product (D10: 39 nm; D50: 112 nm; D90: 310 nm)
300 nm product (D10: 52 nm; D50: 298 nm; D90: 652 nm)
70 nm product (D10: 24 nm; D50: 72 nm; D90: 284 nm)
100 nm product (D10: 34 nm; D50: 101 nm; D90: 308 nm)
400 nm product (D10: 66 nm; D50: 403 nm; D90: 811 nm)
50 nm product (D10: 15 nm; D50: 51 nm; D90: 194 nm)
*2: Reductant content (parts by mass) relative to 100 parts by mass of copper particles
*3: Acrylic resin content (parts by mass) in acrylic binder relative to 100 parts by mass of copper particles
*4: Plasticizer content (parts by mass) relative to 100 parts by mass of acrylic resin

As can clearly be seen from Table 1, cracking of a dried film was observed in the Comparative Examples in which the glass-transition point of a transfer-type sheet-shaped bonding material was outside of a range of not lower than −35 °C and not higher than 25 °C, whereas cracking of a dried film did not arise, excellent transferability was achieved even with mild transfer conditions under which sintering of copper particles does not proceed, and sufficient bonding strength could be ensured even in low-temperature bonding at 250 °C in the Examples in which the glass-transition point of a transfer-type sheet-shaped bonding material was within a range of not lower than −35 °C and not higher than 25 °C. In particular, a high shear strength of 50 MPa or more was achieved in some of the Examples in which the content of an acrylic binder, the content of a reductant, and the mean particle diameter of copper particles were optimized.

### INDUSTRIAL APPLICABILITY

The transfer-type sheet-shaped bonding material according to the present disclosure has industrial applicability in an application of bonding electronic components. A specific example thereof is an application of bonding components such as boards, elements, etc. in high-temperature environments such as in electronic devices referred to as powder devices where it is difficult to use a bonding material such as solder.

1. A transfer-type sheet-shaped bonding material obtained through application and drying, on a resin substrate, of a paste that comprises copper particles, a reductant, an organic material including a resin and optionally including a plasticizer, and a solvent, wherein
the transfer-type sheet-shaped bonding material has a glass-transition point of not lower than −35 °C and not higher than 25 °C.

2. The transfer-type sheet-shaped bonding material according to claim 1, wherein the resin is composed of an acrylic resin.

3. The transfer-type sheet-shaped bonding material according to claim 1, wherein content of the resin is not less than 1.0 parts by mass and not more than 5.0 parts by mass relative to 100 parts by mass of the copper particles.

4. The transfer-type sheet-shaped bonding material according to claim 1, wherein the plasticizer is composed of one or more selected from the group consisting of butyl phthalyl butyl glycolate, dimethyl phthalate, dioctyl phthalate, and diisodecyl phthalate.

5. The transfer-type sheet-shaped bonding material according to claim 1, wherein content of the plasticizer is not less than 10 parts by mass and not more than 50 parts by mass relative to 100 parts by mass of the resin.

6. The transfer-type sheet-shaped bonding material according to claim 1, wherein the reductant is composed of triethanolamine.

7. The transfer-type sheet-shaped bonding material according to claim 1, wherein content of the reductant is not less than 3 parts by mass and not more than 9 parts by mass relative to 100 parts by mass of the copper particles.

8. The transfer-type sheet-shaped bonding material according to claim 1, wherein the copper particles have a mean particle diameter of not less than 70 nm and not more than 300 nm.
